(19) United States
(12) Patent Application Publication
(10) Pub. No.: US 2011/0060882 A1
(43) Pub. Date: Mar. 10, 2011

(54) Request Batching and Asynchronous Request Execution For Deduplication Servers

(76) Inventor: Petros Efstathopoulos, Culver City, CA (US)

(21) Appl. No.: 12/554,574

(22) Filed: Sep. 4, 2009

(51) Int. Cl. G06F 12/16; G06F 9/44

(52) U.S. Cl. 711/162; 719/328; 711/E12.103

(57) ABSTRACT

A system and method for processing disk access requests on a deduplication backup server coupled to a storage device. The storage device may store a first set of one or more data items where at least a portion of each data item is stored as a reference to a comparable portion of a stored data item. Disk access requests may be received. Accordingly, disk access requests may be generated based on received disk access requests. At least one generated disk access request references one of the first set of data items. The method may include obtaining, for each of at least two generated disk access requests, data storage location information associated with a corresponding data item stored on the disk. The method may include determining an execution sequence for the generated disk access requests based on the data storage location information and issuing generated disk access requests in the execution sequence.

### FIELD OF THE INVENTION

The present invention relates to systems for deduplicating and storing data. More specifically, it relates to a method and system for accessing data stored by a computer system that deduplicates data.

### DESCRIPTION OF THE RELATED ART

Many of today's organizations rely on computer systems and computer data to perform important functions. Some organizations may operate multiple interconnected computer systems and these systems may produce data and/or receive data from external computer systems. Organizations may use computer data of different types, file sizes and file formats. While much of this data may be valuable to the organization, it may be easily lost (e.g., by computer system failure or by human error). Consequently, many organizations may take precautions against such potential loses by, for example, periodically backing up data to another system. Frequently, the backup system may reside at another physical location (e.g., a centralized backup facility) and in many cases, the backup facility will receive data from multiple locations (e.g., different offices of an organization) via a computer network (e.g., a private computer network or the Internet).

Backup facilities (and backup systems) typically manage tremendous quantities of data. For many reasons, including the quantity of data and the multiple sources of data, portions of one incoming data stream are often duplicated in another incoming data stream or in previously stored data. Managers of backup facilities generally strive (e.g., for cost reasons) to reduce the amount of storage space required to store data. A commonly used technique for reducing storage space is data deduplication and computer storage servers that perform data deduplication tasks are commonly referred to as deduplication servers.

Deduplication servers may identify identical blocks of data in files and between files and store a single copy of each identical block for all files using it. While this technique may make better use of available disk space, it may remove data locality properties that may make disk accesses efficient. Consequently, a deduplication server may receive multiple requests for information that is stored on random disk locations. Serving these requests in-order (and, for example, many times one-by-one) may hurt performance significantly, because the data is distributed across the disk. Accordingly, improvements in deduplication methods are desired.

### SUMMARY OF THE INVENTION

Described herein are embodiments relating to a system and method for processing disk access requests on a backup server coupled to a storage device.

The storage devices may store a set of one or more of data items. In the set of data items stored, at least a portion of each data item may be stored using a reference to a comparable portion of a stored data item.

One or more disk access requests may be received. In some embodiments, the received disk access requests may be issued by sub-functions of a deduplication application running on the backup server. For example, the sub-functions may include an indexing unit and a restoration management unit. In some embodiments, the received disk access requests include a disk access request corresponding to a first quantity of data and a disk access request corresponding to a second quantity of data, where the first quantity does not equal the second quantity. The received disk access requests may be received through an application programming interface (API).

Based on the received disk access requests, one or more second disk access requests may be generated based on received disk access requests. At least one generated disk access request may reference one of the set of stored data items stored.

The method further includes obtaining, for each of at least two disk access requests of the generated disk access requests, data storage location information associated with a corresponding data item stored on the disk.

Additionally, an execution sequence may be determined for the generated disk access requests based on the data storage location information. In some embodiments, the received disk access requests are received in a receive sequence and this receive sequence order does not match the execution sequence order of corresponding generated disk access. The determination of the execution sequence may be performed such that a value indicative of a seek time associated with the generated disk access requests is reduced.

The generated disk access requests may be issued in the execution sequence. In some embodiments, the generated disk access requests are issued in the execution sequence in response to determining that the number of the generated disk access requests satisfies a first threshold.

Other embodiments relate to a memory medium that comprises program instructions executable to perform the methods described above.

In some embodiments, the method described above may be implemented in a computer system that includes a processor and a memory medium coupled to the processor. The memory medium may store program instructions that are executable to implement two or more requesting modules and a disk access management layer (DAML). Similar to descriptions above, the requesting modules may be configured to issue disk access requests corresponding to a storage device coupled to the computer system. As also indicated above, the storage device may store a set of data items and at least a portion of each data item may be stored using a reference to a comparable portion of a stored data item.

The DAML may be configured to receive disk access requests from the requesting modules and generate disk access requests based on the received of disk access requests. At least one generated disk access request references one of the set of data items stored. The DAML may be further configured to obtain, for each of at least two generated disk access, data storage location information associated with a corresponding data item stored on the disk. The DAML may also be configured to determine an execution sequence for the generated disk access requests based on the data storage location information and issue the generated disk access requests in the execution sequence.

### BRIEF DESCRIPTION OF THE DRAWINGS

A better understanding of embodiments of the present invention can be obtained when the following detailed description of the preferred embodiment is considered in conjunction with the following drawings, in which:

FIG. 1 illustrates a system in which an embodiment of the invention may reside;

FIG. 2 depicts a block diagram of an exemplary computer system according to an embodiment of the invention;

FIG. 3 illustrates components of a backup server according to an embodiment of the invention;

FIGS. 4a and 4b illustrate exemplary operation of a backup server in association with backup storage according to an embodiment of the invention;

FIG. 5 is a flow chart illustrating the behavior of a backup server according to an embodiment of the invention; and

FIG. 6 is a block diagram showing components stored in memory according to an embodiment of the invention.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

In the following description, numerous specific details are set forth to provide a thorough understanding of the present invention. However, one having ordinary skill in the art should recognize that the invention may be practiced without these specific details. In some instances, well-known circuits, structures, and techniques have not been shown in detail to avoid obscuring the present invention.

### Embodiment Illustrations

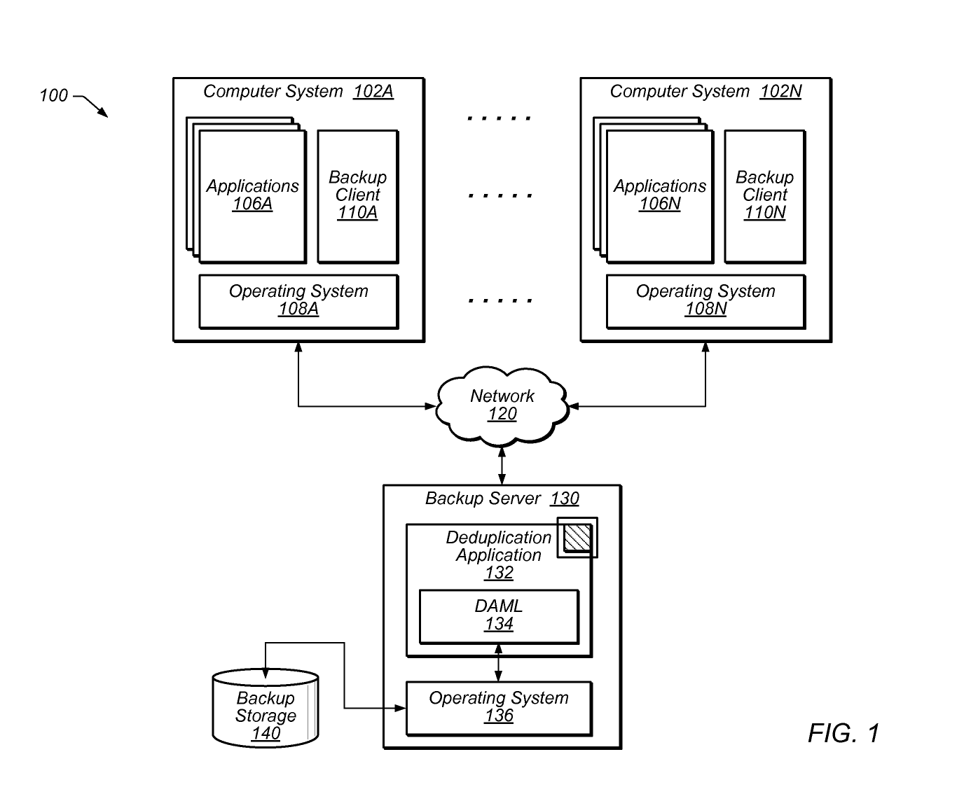

FIG. 1 is a block diagram representing one or more embodiments. System 100 includes a plurality of computer systems 102A-N coupled to a network 120. Each computer system 102 may include one or more applications 106 (shown as 106A-N), which may be text processors, databases, or other repositories managing images, documents, video streams, or any other kind of data. Each computer system 102 may include an operating system 108 (shown as 108A-N), which manages data files for computer system 102. Each computer system 102 may also include a backup client application 110 (shown as 110A-N) which may cooperate with backup server 130 coupled to network 120 to backup files stored in local storage devices associated with each computer system 102.

Backup server 130 may include deduplication application component 132 according to one or more embodiments. A backup server (e.g. backup server 130) that executes a deduplication application (e.g. deduplication application component 132) may be referred to as a “deduplication backup server.” In descriptions below, references to backup servers and descriptions of backup servers may be read as also applying to (but not being limited to) deduplication backup servers. The deduplication application 132 may include a disk access management layer (DAML) 134 that may manage disk access requests, as described herein. Data of backup server 130 may be stored in backup storage 140, which may include one or more disk storage devices. The storage 140 may be included internal or external to the backup server 130, as desired. In some embodiments, the storage 140 may include one or more storage devices that are internal and one or more storage devices that are external to the backup server 140. Backup storage 140 may be accessed through calls to an operating system 136 running on backup server 130 and/or calls to backup disk drivers. Periodically, a backup client 110 may backup files that are stored in a respective local storage device 104 of each host system 102 to backup server 130. Similarly, the backup client 110 may restore files that are stored by the backup server 130. The deduplication application component 132 may perform deduplication functions accordingly and may retrieve and/or store data subject to deduplication from/to backup storage 140.

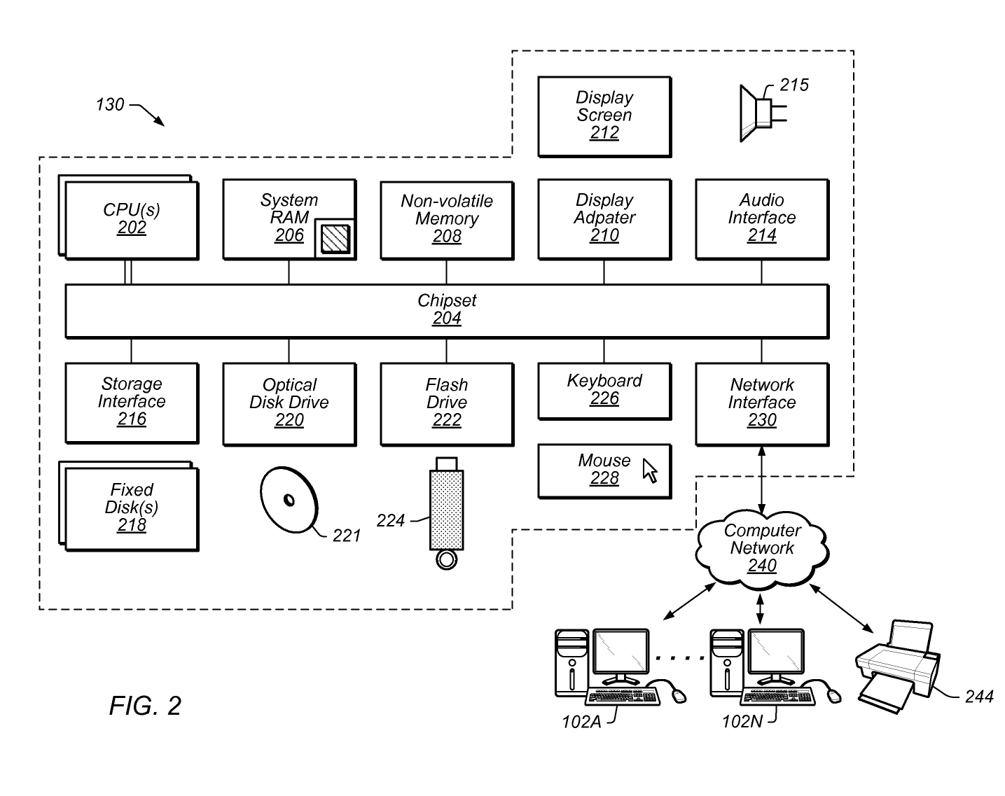

FIG. 2 depicts a block diagram of a backup server system (e.g., a deduplication backup server system) 130 according to one or more embodiments. The depicted system 130 includes chipset 204 (e.g., including one or more integrated circuits (ICs)), which may implement some common computer interface functions (e.g., keyboard controller, serial ports, input/output control and so on). Chipset 204 may connect (e.g., through one or more buses and/or one or more interfaces) various subsystems (e.g., major components) of computer system 130, such as one or more central processor units (CPUs) 202, system random access memory (RAM) 206, non-volatile memory (e.g., Flash ROM) 208, an external audio device, such as a speaker system 215 via an audio output interface 214, a display screen 212 via display adapter 210, a keyboard 226, a mouse 228 (or other point-and-click device), a storage interface 216, an optical disk drive 220 configured to receive an optical disk 221, and a flash drive interface 222 configured to receive a portable flash memory stick 224. The depicted system 130 also includes a network interface 230 that may allow system 130 to be coupled to computer network 240 and thereby allow computer system 130 to connect to other networked devices such as computer systems 102A-N, network printer 244 and network storage devices (not shown).

Chipset 204 allows data communication between CPU(s) 202 and system RAM 206. System RAM (e.g., system RAM 206) is generally the main memory into which an operating system and application programs are loaded. Non-volatile memory 208 may contain, among other code, a Basic Input-Output system (BIOS) which controls basic hardware operation such as the interaction with peripheral components. Applications resident on computer system 130 may be stored on and accessed via a computer readable medium, such as one or more hard disk drives (e.g., fixed disk(s) 218), an optical disk (e.g., optical disk 221), or other storage medium (e.g., flash drive memory stick 224). Additionally, applications may be in the form of electronic signals modulated in accordance with the application and data communication technology when accessed via network interface 226.

Many other devices or subsystems (not shown) may be connected in a similar manner (e.g., document scanners, digital cameras and so on). All of the devices depicted in FIG. 2 need not be present to practice the present invention. The depicted devices and/or subsystems may be interconnected in different ways from that illustrated in FIG. 2. The operation of a computer system such as that shown in FIG. 2 is readily known in the art and is not discussed in detail in this application. Code to implement the present disclosure may be stored in computer-readable storage media such as one or more of system memory 206, fixed disk(s) 218, optical disk 221 or flash memory stick 224. The operating system provided on computer system 130 may be Microsoft Windows Server®, Microsoft Storage Server®, UNIX®, Linux®, or another known operating system.

Storage interface 216, as with the other storage interfaces of computer system 130, may connect to a standard computer readable medium for storage and/or retrieval of information, such as fixed disks 218 (e.g., hard disks). In some embodiments fixed disks 218 may be held within the housing of computer system 130, in other embodiments fixed disks 218 may be external to the housing of computer system 130. In some embodiments fixed disks 218 may be accessed through another interface of computer system 130 (e.g., network interface 230). In some embodiments, fixed disks 218 may form part of backup storage 140. In some embodiments, fixed disks 218 may be used for purposes other than backup storage and backup storage 140 may be external to backup system 130 as shown in FIG. 1. Network interface 230 may provide a direct connection to a remote computer system via a direct network link to the Internet, e.g., via a POP (point of presence). Network interface 230 may provide such connections using wireless techniques, including digital cellular telephone connection, Cellular Digital Packet Data (CDPD) connection, digital satellite data connection or the like.

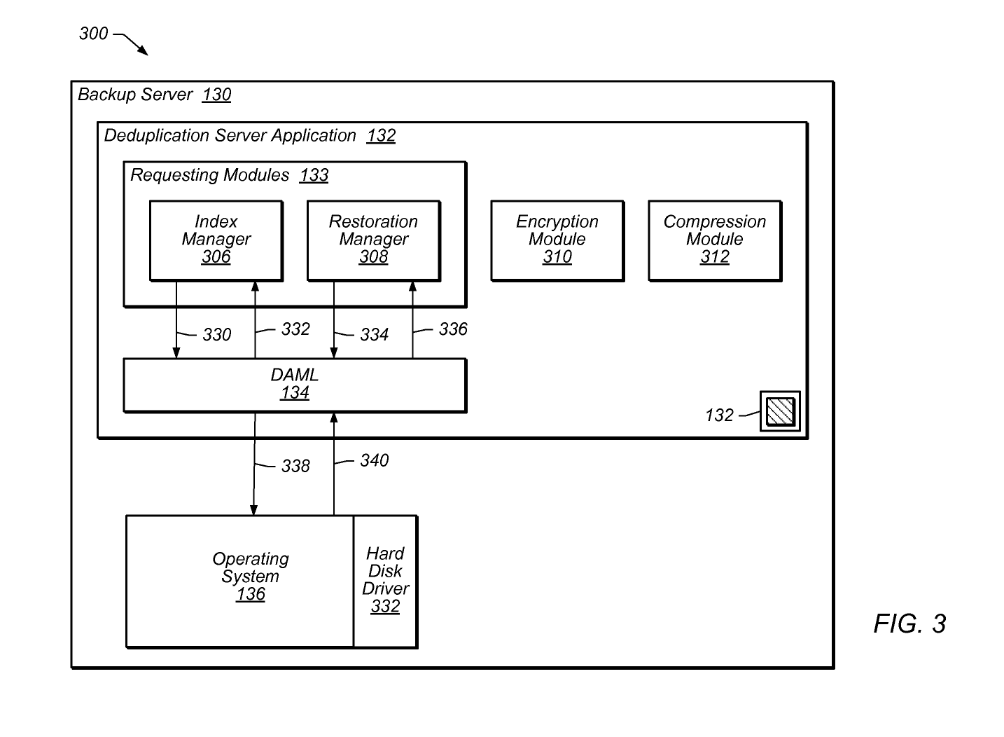

FIG. 3 depicts a block diagram of backup server 130 according to one or more embodiments. The backup server comprises deduplication server application 132 and operating system (OS) 136. OS 136 interfaces to one or more hard disk drivers 322 that may be employed during the service of calls made to the operation system (e.g., read from disk, write to disk). The depicted deduplication server application 132 comprises various sub-components including index manager 306, restoration manager 308, encryption module 310, compression module 312 and DAML 134.

Deduplication generally involves the creation of identification (ID) values (e.g., fingerprints) for stored data segments and these IDs may be stored in an index. Such IDs may be created (or examined) when a deduplication server (e.g., backup server 130) handles a request to store (or retrieve) data. The management of accesses to an ID index (or an alternative structure) may be performed by an index manager (e.g., index manager 306) residing within the deduplication server application 132. Since indexes are commonly stored on hard disk and consequently index managers (e.g., index manager 306) may issue data access requests to load/store portions of an index.

In some embodiments, a restoration manager (e.g., restoration manager 308) may be used within a deduplication server (e.g., deduplication server 130) to retrieve stored data. A restore process may be performed when a remote system (e.g., computer system 102A) wishes to restore data that was backed up onto a deduplication server (e.g., backup server 130). The location of the stored data may be found with help from an index manager (e.g., index manager 306). To restore data, restoration managers may issue disk access requests to retrieve data stored in backup storage (e.g., hard disk(s) of backup storage 140). The quantities of data associated with restoration manager disk access request are typically much larger (e.g., 128 MB) that those associated with an index manager disk access request (e.g., 2 kB).

In some embodiments, other sub-functions within the deduplication server, such as encryption module 310 and compression module 312, may respectively provide data security and data compression/decompression capabilities. In some embodiments, an encryption module 310 and compression module 312 may not make disk access requests. In certain embodiments, encryption module 310 and compression module 312 may rely on another module (e.g., restoration manager 308) to provide data movements on/off disk. However, in alternate embodiments, all of the modules may be configured to provide disk access requests.

In the illustrated embodiment, index manager 306 may submit disk access requests to DAML 134 as depicted by arrow 330. For example, index manager 306 may request several portions of an ID index file in order to perform a fingerprint comparison. In addition, and possibly at the same time, restoration manager 308 may submit disk access requests as depicted by arrow 334. For example, restoration manager 308 may request data from disk to service a backup request. DAML 134 may receive disk access requests from index manager 306, restoration manager 308 and any other modules/sub-functions that may generate requests in a certain order (e.g., order in which the requests were sent). In some embodiments, DAML 134 may wait to issue (e.g., to the operating system) disk access requests corresponding to the access requests it has received. The DAML 134 may, for example, wait until a certain number of requests have been received and may also wait until it obtains information about the physical location of received disk access requests.

The DAML 134 may use such physical location information along with a knowledge of factors affecting hard disk performance to determine a disk access request execution order (or issue order) that is expected to benefit performance. DAML 134 may process received disk access requests (e.g., re-order, translate each request) and issue corresponding requests (e.g., to OS 338 and/or to hard disk driver 332) in an execution order (e.g., in an order beneficial for execution). OS 338 and/or hard disk driver 332 may then execute the requests and generate and send responses 340 (e.g., using data received from a hard disk) to DAML 134. Thus, according to various embodiments, the DAML may generate the disk access request execution order and may provide corresponding access requests to the operating system 136, or may bypass the operating system 136 and interact directly with the hard disk driver 332, as desired.

DAML 134 may then generate (and send) responses corresponding to the disk access requests it received. For example, DAML 134 may send disk access responses to index manager 306 as depicted by arrow 332. Additionally, or alternatively, DAML 134 may send disk access responses to restoration manager 308 are depicted by arrow 336. Note that, in some embodiments, the order in which disk access requests (as depicted by arrows 330, 334) are received by DAML 134 and the order that disk access responses (as depicted by arrows 332, 336) are sent may be quite different. Additionally, the disk access requests may be executed asynchronously. In such embodiments where disk access requests are executed asynchronously, a disk access response sent by DAML 134 may include a tag to allow the issuing module to identify a corresponding request.

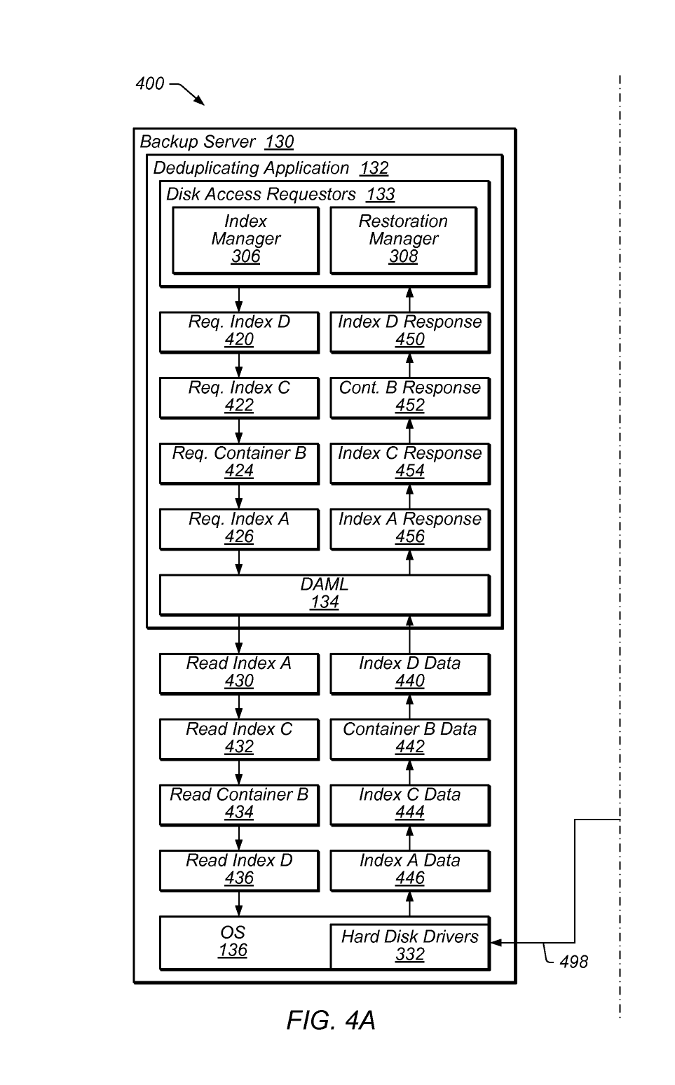

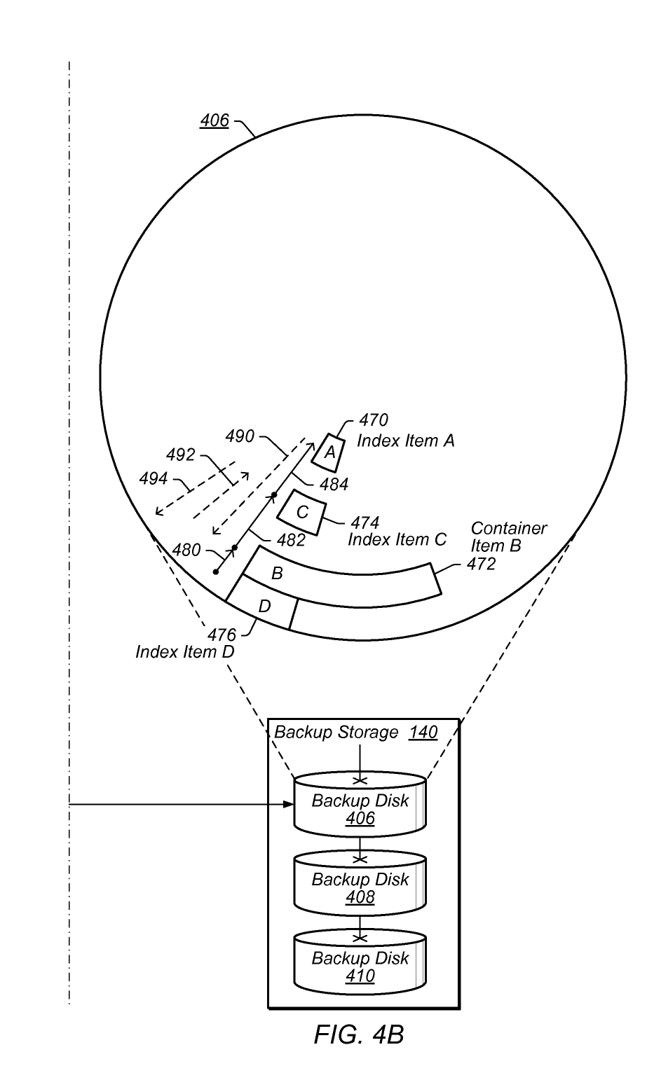

FIGS. 4a and 4b form a block diagram that illustrates an operational example according to one or more embodiments of the invention. FIGS. 4a and 4b depict a system 400 comprising a backup server 130 coupled to backup storage 140. A portion of backup storage 140 (e.g., hard disk 406) is depicted in expanded detail. Also depicted on the block diagram are software components of the backup server 130 and examples of disk related transactions transferring between software components.

In depicted system 400, the backup server 130 comprises a deduplication application 132 that comprises DAML 134 and disk access requestors 133. The depicted disk access requestors 133 comprise index manager 306 and restoration manager 308. Note that disk access requestors 133 represents a category of certain software modules/functions (e.g., modules that may issue disk access requests) and that depicted block 133 is not intended to suggest that components found within the block (e.g., index manager 306, restoration manager 308) are somehow tied together or that they fall within a hierarchical structure.

In the depicted embodiment, disk access requestors 133 issue four disk access requests (420-426) to DAML 134 (e.g., requesting modules issue a first plurality of disk access requests). This group of requests is depicted as arriving at DAML 134 in the following sequence (from first arriving to last arriving), request index item “A” 426, request container item “B” 424, request index item “C” 422 and request index item “D” 420. In the depicted embodiment, access requests for index items (e.g., 426, 422 and 420) may be considered to originate from index manager 306 and access requests for container item 424 may be considered to originate from restoration manager 308.

In some embodiments, as (or after) DAML 134 receives disk access requests 420-426, DAML 134 may generate (e.g., translate from received requests 420-426, generate based on received requests 420-426) a corresponding group of requests (e.g., requests 430-436). In some embodiments, the generation of disk access requests 430-436 may involve little or no translation from the received requests 420-426. In some embodiments, the generation of disk access requests 430-436 may involve reformatting a portion of received requests, standardizing a portion of received requests and/or converting a portion of received requests. Either as part of this generation process, or separately, or in conjunction, DAML 134 may also determine/obtain physical information associated with generated requests 430-436 (e.g., DAML 134 may determine disk locations associated with each requested data item). For ease of explanation, the data items associated with disk access requests 430-436 are depicted as residing on one hard disk (hard disk 406) within backup storage 140. Commonly, DAML 134 may receive requests that correspond to data spread across a number of hard disks (e.g., hard disks 406, 408 and 410, e.g., within storage 140).

In the depicted embodiment, backup disk 406 is shown in expanded detail and the physical locations (and storage dimensions) of data associated with the generated requests 430-436 are also indicated. In the depicted embodiment, Index item D 476 resides on the outer perimeter of backup disk 406. Also depicted, moving inward on backup disk 406, are container items B 472, index item C 474 and index item A 470. Two sets of arrows are shown on the surface of disk 406. Note that the depicted arrangement of data items 470-476 (e.g., their alignment to a disk radius) is purposefully simplified for ease of explanation; commonly, requested data items may exhibit no such alignment.

Arrows 480, 482 and 484 illustrate the radial distance between neighboring data items. Arrow 480 depicts the radial distance between index item D 476 and container item B 472, arrow 482 depicts the radial distance between container item B 472 and index item C 474 and arrow 484 depicts the radial distance between index item C 474 and index item A 470. The total radial distance of arrows 480, 482 and 484 may be indicative of the total seek time associated with a hard disk read/write head reading the four depicted data items in the sequence D, B, C, A.

Dashed line arrows 490, 492 and 494 also illustrate the radial distance between the same four data items, as per the order in which associated disk access requests are received by DAML 134 (i.e., alphabetical order). Arrow 490 depicts the radial distance between index item A 470 and container item B 472, arrow 492 depicts the radial distance between container item B 472 and index item C 474 and arrow 494 depicts the radial distance between index item C 474 and index item D 476. The total length of arrows 490, 492 and 494 may be indicative of the total seek time associated with a hard disk read/write head reading the four depicted data items in the sequence A, B, C D.

By determining physical information (e.g., the location of data items) associated with generated disk access requests 430-436, DAML 134 may estimate certain performance benefits (e.g., a reduction in total seek time) associated with issuing disk access requests 430-436 in a different order (e.g., D, B, C, A) from the received order (e.g., A, B, C, D of corresponding received requests 420-426. In the depicted embodiment, DAML 134 receives disk access requests 420-426 in the order A, B, C, D and issues corresponding requests 430-436 in the order in the order D, B, C, A so that the read/write head of hard disk 406 seeks to neighboring data items (as illustrated by arrows 480-484), and thus performance may be improved. Since requests (e.g., requests 430-436) issued by DAML 134 may be grouped to allow reordering, disk access requests issued by DAML 134 may be considered to be “batched” requests.

In some embodiments (e.g., depicted system 400), disk access requests 430-436 issued by DAML 134 may be high level requests (even though DAML 134 may utilize low level physical knowledge to determine a request order) such as may be made via an API. OS 136 and/or hard disk drivers 332 may handle DAML issued disk access requests by communicating 498 with backup storage system 140. Backup storage system 140 may perform functions under the control of backup server 130 (e.g., read data items from disk) and send responses (e.g., requested data) back to the OS 136 and hard disk drivers 332. OS 136 and/or hard disk drivers 332 may then return disk access responses (e.g., 440-446) corresponding to disk access requests issued by DAML 134. In the depicted embodiment, DAML 134 issues the following disk access requests (from first issued to last issued), read index item “D” 436, read container item “B” 434, read index item “C” 432, read index item “A” 430. After execution of each request, OS 136 may issue the following responses (from first issued to last issued), read index item “D” data 440, read container “B” data 442, read index item “C” data 444 and read index item “A” data 446. Note that, in the depicted embodiment, OS 136 executes and generates responses to received disk access requests in the order in which those requests were received from DAML 134 (e.g., D, B, C, A).

In the depicted embodiment of FIGS. 4a and 4b, DAML 134 receives disk access responses (e.g., read data, write status) from OS 136 in a different order (e.g., D, B, C A) from the order in which it received corresponding requests (e.g., A, B, C, D) from disk access requesters 133. In some embodiments, such as the depicted embodiment, when execution of the disk access requests is performed in an asynchronous manner (e.g., out of order), DAML 134 may generate responses (e.g., to disk access requests) in a way that allows a requesting module/function to match an issued request with a received response. For example, a requesting module (e.g., index manager 306 or restoration manager 308) may register (e.g., when submitting a disk access request) a “call back” function with DAML 134. These call back functions may be used, by DAML 134, to send responses to respective requesting modules. In the depicted embodiment, DAML 134 generates the following responses (from first issued to last issued) index item “D” response 450, container “B” response 452, index item “C” response 454 and index item “A” response 456. These responses are received by disk access requesters 133. For example, index manager 306 receives responses 450, 454, 456 and restoration manager 308 receives response 452.

Note that the operational example illustrated in FIGS. 4a and 4b is simplified for ease of explanation, as are aspects of the depicted embodiment. For example, in the illustrated operational example the number of disk access requests is small (e.g., 4), the requests are all read requests, all the data resides on one hard disk, all the requested data is aligned to a radius on the hard disk and the portrayed dimensions of data items (e.g., items 470-476) suggests requested data blocks are of a similar size. However, these simplifications are not intended to be indicative of limitations. Some embodiments may process large number of disk access requests, some embodiments may group large numbers of disk access requests before reordering, some embodiments may process disk access requests for data spread across a hard disk, some embodiment may process disk access requests that contain a mixture of read requests and write requests and some embodiments may process disk access requests spread across different types of backup storage devices. Finally, in some embodiments requested data blocks may be of markedly different sizes, for example 128 MB and 4 kB. Additionally, while a typical circular hard disk drive is depicted in FIG. 4B, other types of hard disk drives, such as solid state drives are envisioned. Accordingly, the hard disk drive addresses may be addressed in a sequential manner, e.g., for better efficiency.

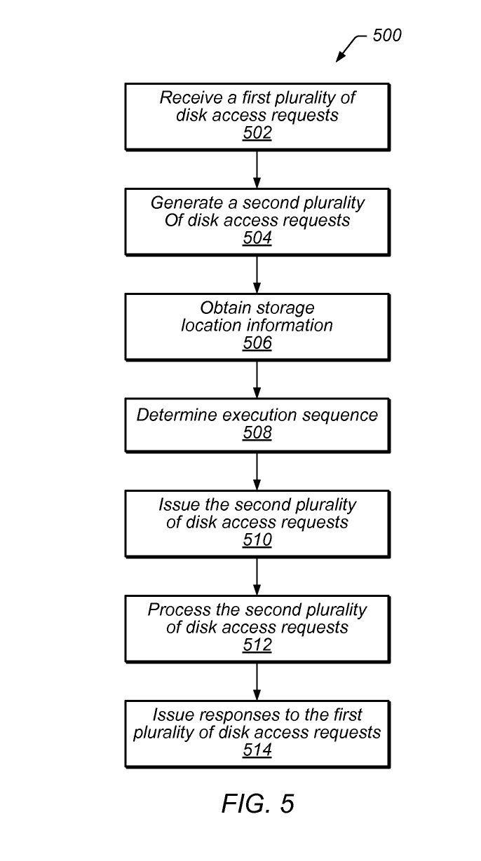

FIG. 5, depicts a flow chart of an exemplary method 500 for processing disk access requests in accordance with one or more embodiments of the present technique.

As depicted at block 502, method 500 may include receiving a first plurality of disk access requests (DARs). For example, in one embodiment, method 500 may include receiving DARs that are issued by an index manager that may wish to examine portions of an index residing on disk. In some embodiments, DARs may be received by a DAML (e.g., DAML 134) from a number of client components, for example, index manager 306 and restoration manager 308. DARs may request markedly different quantities of data (e.g., 2 kB, 128 MB) and may request that data is read (e.g., retrieved) or written (e.g., stored). In some embodiments, DARs may be received from certain components for small quantities of data (e.g., index manager 306 requesting 2 kB) and DARs may also be received from certain client components for large quantities of data (e.g., restoration manager 308 requesting 128 MB). In some embodiments, a DAML (e.g., DAML 134) may support an API and “high level” DARs may be received (from various requesting components) by the DAML through the API. In some embodiments, a DAML (e.g., DAML 134) may also receive “lower level” DARs (e.g., requests that provide detailed description of the data, such as the physical location of the data) from requesting components. In some embodiments, call-back functions may be provided (or registered) with a DAML (e.g., by requesting client components requestors), providing the DAML with a mechanism for returning DAR responses (e.g., requested data) to the appropriate requesters.

In the illustrated embodiment, method 500 may also include generating a second plurality of disk access requests DARs, as depicted at block 504. As previously described, in some embodiments a DAML may receive DARs from a variety of requesting components and the DARs received may be of various types (e.g., high level requests, low level requests, API requests) and for various quantities of data (e.g., 2 kB, 128 MB). In some embodiments, a DAML may generate a second plurality of DARs (that hereafter may be referred to as “DMAL DARs” or “DDARs”) based on received DARs (for example based on disk access requests 420-426). In some embodiments DDARs (e.g., disk access requests 430-436) may be considered to be translations of received DARs. In some embodiments, a portion of the DDARs may be similar to, or even identical to, a portion of received DARs. Generating DDARs from received DARs may be performed for a variety of reasons (e.g., to support the management of requests, to improve the conformity of request formats, to obtain information, to translate requests into a format suitable for issuing to another software component). In some embodiments, DARs may be issued and received in various fashions (e.g., sporadically, periodically, intermittently or continuously). Some embodiments, such as the depicted embodiment 500, may incorporate a loop, where DARs (e.g., sporadically issued DARs, intermittently issued DARs) may be received and processed prior to issuing.

In the illustrated embodiment, method 500 may also include obtaining storage location information as depicted at block 506. For example, in some embodiments, physical storage location information (e.g., the location of associated data stored on disk, the disk identifier associated with a request) may be obtained for a portion of the DDAR requests (e.g., DDAR requests that reference data already stored on disk, DDAR requests that request data be read from disk) generated in block 504. In some embodiments, storage information may be obtained for individual DDARs. Generating DDARs at block 504 (e.g., translating higher level DARs into lower level DDARs) may provide a portion of the storage location information.

In the illustrated embodiment, method 500 may also include determining an execution sequence as depicted at block 508. DARs may be issued (and received) in various fashions (e.g., sporadically, periodically, intermittently, continuously). In some embodiments, a DAML may wait until a certain number of DDARs have been generated before starting to determine an execution sequence. More specifically, it may be beneficial (e.g., to backup server performance) to determine the execution sequence for at least a certain number of disk access requests. Consequently, in some embodiments, one or more portions of flow (e.g., 504, 506, 508 and 510) may involve waiting for a certain quantity of requests (e.g., DARs, DDARs) to be available before proceeding.

The determination of an execution sequence may involve determining an issue sequence (e.g., the order that DDARs may be issued by a DAML). The execution sequence may include “reordered” DDARs (e.g., DDARs may be put into an issue order that may differ from the order in which associated DARs may have been received).

In some embodiments, the DAML may iteratively determine an execution sequence, adjusting the execution sequence to accommodate new DDARs. For example, the execution sequence may be adjusted periodically, in response to a request and/or as new DARs are received (e.g., one-by-one) and/or as new DDARs are generated.

The DAML may determine an execution sequence of some DDARs based on the physical locality (e.g., the storage location information obtained in block 506) of stored data that is associated with a portion of the DDARs. Additionally, or alternatively, the DAML may take factors (e.g., other than physical location) into account when performing the determination of an execution sequence. For example, the DAML may consider DDAR request type (e.g., read or write) and/or the DAML may consider replacing a number of requests for data lying in close proximity with a single request for a larger amount of data and/or the DAML may break a request for a large quantity of data into multiple requests for portions of the requested data. In some embodiments, an execution sequence may be iteratively determined for a stream of DDARs generated by block 504, the reordered requests may be counted and the count may be compared to a threshold value. When the threshold is satisfied, the DDARs may be made available for issuing.

In the illustrated embodiment, method 500 may also include issuing (e.g., by the DAML) the second plurality of DARs (e.g., requests 430-436) as depicted at block 510. As previously mentioned, in some embodiments, the second plurality of DARs (e.g., DDARs) may include reformed and reordered versions of the first plurality of DARs (e.g., DARs that were received by a DAML (e.g., requests 420-426) from various requester components (e.g., index manager 306, restoration manager 308)). In some embodiments, a DAML may issue DDARs to an OS (e.g., OS 136), the DAML may issue DDARs to one or more hard disk drivers (e.g., hard disk driver 332) and/or the DAML may issue DDARs to some other privileged software component, as desired. Note that the deduplication application (e.g., deduplication application 132) containing the DAML may perform other activities (e.g., encryption in module 310, compression in module 312) while DDARs issued by the DAML are handled by an OS (or other privileged software).

In the illustrated embodiment, method 500 may also include processing the second plurality of DARs (e.g., DDARs), as depicted at block 512. In some embodiments, the DAML may issue DDARs (e.g., 430-436) and these DDARs may be processed by an operating system (e.g., OS 136) running on the backup server, by one or more hard disk drivers (e.g., hard disk drivers 332) and/or by other privileged software running on a backup server. In some embodiments, DDARs may be processed in an issued order that was determined (e.g., by the DAML) to improve backup server performance.

DDARs may be executed asynchronously by an OS, thus providing the DAML with more freedom in issuing requests. In some embodiments, the OS may communicate with a backup storage system (e.g., backup storage 140) to service issued disk access requests (e.g., to move data on/off disk). Processing DDARs may involve privileged software communicating with a backup storage system (e.g., sending commands to read/write data to disk), getting data/or status information from a backup storage system and/or sending responses (e.g., status for writes, requested data for reads) to the issuing DAML.

In the illustrated embodiment, method 500 may also include issuing DAR responses, as depicted by block 514. In some embodiments, the DAML may receive an OS response (e.g., Index “A” data 446) to a DDAR that the DAML previously issued (e.g., read index “A” 430). The DAML may then issue a response (e.g., index “A” response 456) to a corresponding DAR that the DAML previously received (e.g., request index “A” 426). In some embodiments, the DAML may generate DAR responses asynchronously to receiving DARs. For example, the DAML may use a call-back function that may have been previously registered by a client requestor/component (e.g., when an associated DAR was issued or received). In certain embodiments, a call-back function may allow the DAML to send a DAR response to the requesting component that issued a corresponding DAR. In some embodiments, the DAML may include some form of transaction key and/or requestor identification as part of a DAR response in order to allow a requesting component to match a DAR response with a DAR.

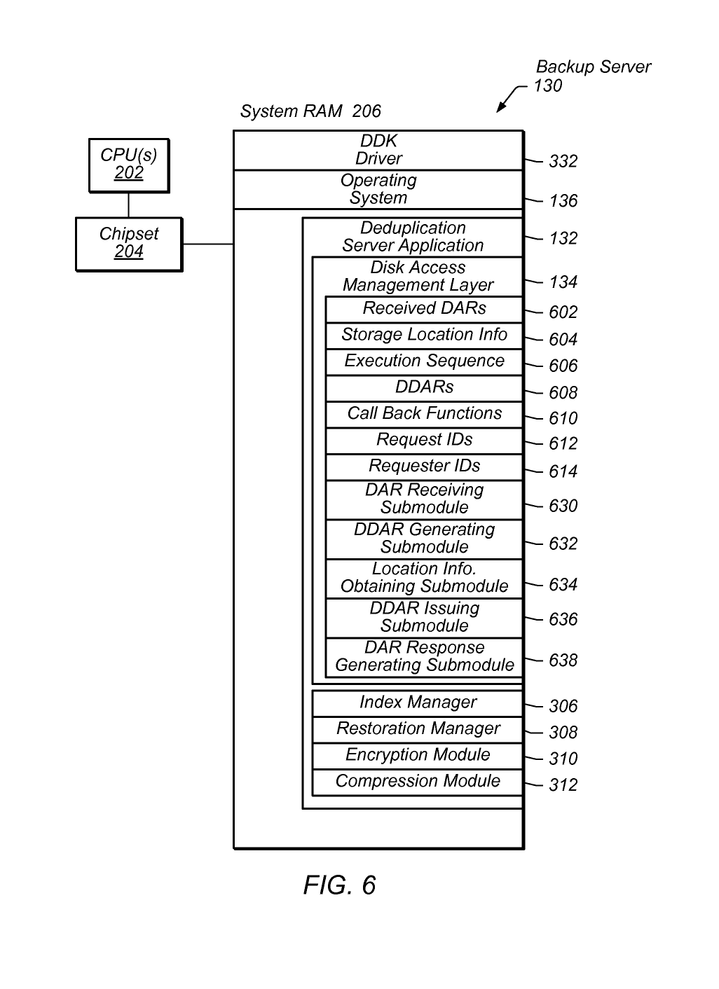

FIG. 6 depicts a diagram of an exemplary backup server 130 according to some embodiments. In the depicted embodiment, backup server 130 comprises one or more central processing units (CPUs) 202, chipset 204 and system RAM 206. Typical embodiments of backup server 130 may include other components not depicted in FIG. 6 (e.g., storage interface, optical disk drive, non volatile memory etc.) The depiction of backup server 130 shown in FIG. 6 is primarily intended to describe software components of backup server 130. In FIG. 6, software components are depicted as residing in system RAM 206; however, in some embodiments, portions of the components may be stored in other locations (e.g., on hard disk, in non-volatile memory, on remote mass storage, on a network drive, on optical disk).

In the depicted embodiment of FIG. 6, system RAM 206 stores the following elements: an operating system 136 that may include procedures for handling various basic system services and for performing hardware dependent tasks; one or more hard disk drivers 332, that may be work in concert with the operating system 136 to move data on and off disk storage devices (e.g., backup storage 140); a deduplication server application 132 that may be used to backup and restore data to hard disks (e.g., backup storage 140). In other embodiments, system RAM 206 may store a superset or a subset of such elements.

In the depicted embodiment of FIG. 6, the deduplication server application 132 includes the following elements: a disk access management layer (DAML) 134 for managing disk access requests to backup storage, a index manager 306 for managing a deduplication server index, a restoration manager 308 for restoring backed up data items, an encryption module 310 for encrypting and decrypting backup data items and a compression module 312 for compressing and decompressing backup data items. In other embodiments, the deduplication server application may contain a superset or a subset of such elements.

In the depicted embodiment of FIG. 6, the DAML 134 includes the following elements: DARs 602 that were received from requesting components (e.g., index manager 306), DDARs 608 that were generated by the DAML 134, storage location information 604 associated with disk access requests (e.g., DDARs 608), execution sequence information 606 to support the issuance of DDARs in an execution sequence, one or more call back functions 610 to support the return of data (or status) to a requesting components via a call back functions, request identification information 612 to support the return of data (or status) to a requesting component using a request identifier, requester identification information 614 to support the return of data (or status) to a requesting component using a requester identifiers, a DAR receiving module 630 for handling the reception of DARs by DAML 134, a DDAR generating module 632 for generating DDARs for issuing, a location information gathering module 634 for obtaining location information associated with DDARs, a DDAR issuing module 636 for issuing DDARs in an execution sequence and a DAR response module 638 for generating responses (e.g., supplying data and/or request status) to DAR requests.

### Additional Information

The following passage is intended to provide additional information and describe additional embodiments so that the reader will be provided with a more complete understanding of the invention described herein. Those skilled in the art will appreciate that many types of embodiments are possible and the systems and methods described above are not limited by this section.

Some embodiments may employ a software layer, known as a disk access management layer (DAML), that may help amortize the disk access randomness (that may be introduced by deduplication) and may increase sequential disk accesses and may improve disk access performance.

Some embodiments may involve servicing disk access requests for a variety of data sizes or granularities. Disk access requests processed by a deduplication server may be generated by various sub-functions and these requests may have different granularities. For example, an indexing unit may issue disk access requests at the data segment granularity (e.g., to verify the existence or access a data segment of a few KB). In contrast, a storage management unit may request access to a whole storage container (e.g., a bulk storage unit of 128 MB or more). In certain embodiments high level requests from different sub-functions (and of granularities) may be received, understood (e.g., by the DAML) and translated to equivalent basic physical disk accesses, regardless of the source of the request.

In some embodiments, disk access requests may be serviced asynchronously. In one embodiment, system components (e.g., an indexing module of a deduplication application) may submit disk access requests (e.g., to the DAML layer) for asynchronous execution. A callback function may be submitted along with the request. This may allow the system to overlap disk I/O with other operations of the backup server (e.g., deduplication server). These other operations may include, for example, CPU calculations of new data fingerprints, network I/O (e.g., communication with the client or reception of next batch of queries). When disk I/O results are ready (e.g., at the DAML layer), the callback function may be invoked to return the results to the calling module.

In certain embodiments, disk access requests that are received in certain order may be translated into disk access patterns (e.g., by the DAML) and then reordered for execution so that disk accesses occur more efficiently. Note that, in general, read requests may be freely reordered but that, in order to maintain data integrity, write requests and read requests addressed to the same disk address may not be reordered. By reordering disk access requests, an embodiment (e.g., a DAML) may be able to improve disk access performance by reducing costs associated with disk seeks.

Some embodiments may provide additional benefits to a backup system (e.g., a deduplication server) that has a co-operating client component, such as Symantec's “PureDisk”™. Such a client may have advance knowledge of disk access requests that it may issue and that knowledge may be shared with a backup server in advance. For example, the client may submit a list of requests (e.g., a backup “schedule” or a list of files that will be accessed in the near future) to the backup server (e.g., before a scheduled backup is due to be performed). The backup server (e.g., DAML-enabled server) may use this shared information to perform pre-fetching of relevant information in an order that was determined to improve the efficiency of disk accesses. Note that, in some situations, backing up data to a deduplication backup server may involve storing a file (e.g. a newly created file, a file with completely new content) to backup storage where no comparable portion of the file is found (e.g. by the deduplication application) to exist on backup storage. Such situations may occur more frequently when the quantity of data stored to the backup storage is relatively low. Thus, in the method described above, each previously encountered portion of a file may be stored as a reference to a comparable stored portion (e.g., a portion of a previously stored file, a previously stored portion of the file being stored). However, in the method described above, some files may contain no previously encountered portions and some files may be stored without the use of a reference to a previously stored portion.

In some embodiments an application programming interface (API) may be provided (e.g., by the DAML) to requesting backup server components. In one embodiment, simple disk access primitives (e.g., “get” or “put”) that accept a variety disk I/O unit descriptors (e.g., segment fingerprints, container IDs, cache entries etc.) as input may be provided. In some embodiments, system software supporting an API (e.g., the DAML) may possess detailed physical knowledge of how and where data is stored and it employ various methods that translate a data object ID (e.g., container ID) into physical disk location.

In some embodiments, asynchronous execution of disk access requests may benefit system performance. Asynchronous execution may allow for the batching of multiple disk access requests while the calling system components are performing other tasks. Once a certain quantity of disk access requests have been received, translated, ordered and issued (e.g., by DAML) corresponding disk accesses may be performed. In certain embodiments, a generic callback function may be provided to requesting client components, but some embodiments may provide a call-back function that is customized for a client component.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable other skilled in the art to best utilize the invention and various embodiments with various modifications as may be suited to the particular use contemplated.

Although the embodiments above have been described in considerable detail, numerous variations and modifications will become apparent to those skilled in the art once the above disclosure is fully appreciated. It is intended that the following claims be interpreted to embrace all such variations and modifications.

1. A computer readable storage medium comprising program instructions for processing disk access requests on a backup server, wherein the program instructions are executable by a processor to:
receive a first plurality of disk access requests, wherein the backup server is coupled to a storage device which stores a first plurality of data items, wherein at least a portion of each data item in the first plurality of data items is stored using a reference to a comparable portion of a stored data item;
generate a second plurality of disk access requests based on the first plurality of disk access requests, wherein at least one disk access request of the second plurality of disk access requests references one of the first plurality of data items stored;
obtain, for each of at least two disk access requests in the second plurality of disk access requests, data storage location information associated with a corresponding data item stored on the disk;
determine an execution sequence for the second plurality of disk access requests based on the data storage location information; and
issue the second plurality of disk access requests in the execution sequence.

2. The computer readable storage medium of claim 1,
wherein the first plurality of disk access requests are received in a receive sequence; and
wherein the receive sequence order of the first plurality of disk access requests does not match the execution sequence order of corresponding requests in the second plurality of disk access requests.

3. The computer readable storage medium of claim 1,
wherein the second plurality of disk access requests are issued in the execution sequence in response to determining that the number of disk access requests in the second plurality of disk access requests satisfies a first threshold.

4. The computer readable storage medium of claim 1, wherein, in receiving the first plurality of disk access requests, the program instructions are further executable to receive one or more disk access requests through an application programming interface (API).

5. The computer readable storage medium of claim 1, wherein, in determining the execution sequence for the second plurality of disk access requests, the program instructions are further executable to determine the execution sequence such that a value indicative of a seek time associated with the second plurality of disk access requests is reduced.

6. The memory computer readable storage medium of claim 1,
wherein the first plurality of disk access requests comprise disk access requests issued by a plurality of sub-functions of a deduplication application running on the backup server; and
wherein the plurality of sub-functions of the deduplication application running on the backup server comprises one or more of:
an indexing unit; or
a restoration management unit.

7. The computer readable storage medium of claim 1, wherein the first plurality of disk access requests comprise:
a first disk access request corresponding to a first quantity of data; and
a second disk access request corresponding to a second quantity of data;
wherein the first quantity does not equal the second quantity.

8. A method for processing disk access requests on a backup server, the method comprising using a computer to perform:
receiving a first plurality of disk access requests, wherein the backup server is coupled to a storage device which stores a first plurality of data items, wherein at least a portion of each data item in the first plurality of data items is stored using a reference to a comparable portion of a stored data item;
generating a second plurality of disk access requests based on the first plurality of disk access requests, wherein at least one disk access request of the second plurality of disk access requests references one of the first plurality of data items stored;
obtaining, for each of at least two disk access requests in the second plurality of disk access requests, data storage location information associated with a corresponding data item stored on the disk;
determining an execution sequence for the second plurality of disk access requests based on the data storage location information; and
issuing the second plurality of disk access requests in the execution sequence.

9. The method of claim 8,
wherein the first plurality of disk access requests are received in a receive sequence; and
wherein the receive sequence order of the first plurality of disk access requests does not match the execution sequence order of corresponding requests in the second plurality of disk access requests.

10. The method of claim 8, wherein the second plurality of disk access requests are issued in the execution sequence in response to determining that the number of disk access requests in the second plurality of disk access requests satisfies a first threshold.

11. The method of claim 8, wherein receiving the first plurality of disk access requests further comprises receiving one or more disk access requests through an application programming interface (API).

12. The method of claim 8, wherein, determining the execution sequence for the second plurality of disk access requests further comprises determining the execution sequence such that a value indicative of a seek time associated with the second plurality of disk access requests is reduced.

13. The method of claim 8,
wherein the first plurality of disk access requests comprise disk access requests issued by a plurality of sub-functions of a deduplication application running on the backup server; and
wherein the plurality of sub-functions of the deduplication application running on the backup server comprises one or more of:
an indexing unit; or
a restoration management unit.

14. The method of claim 8, wherein the first plurality of disk access requests comprise:
a first disk access request corresponding to a first quantity of data; and
a second disk access request corresponding to a second quantity of data;
wherein the first quantity does not equal the second quantity.

15. A computer system comprising:
a processor; and
a computer readable storage medium coupled to the processor, wherein the computer readable storage medium comprises instructions executable by the processor to implement:
a plurality of modules configured to issue a first plurality of disk access requests corresponding to a storage device coupled to the computer system, wherein the storage device stores a first plurality of data items, wherein at least a portion of each data item in the first plurality of data items is stored using a reference to a comparable portion of a stored data item; and
a disk access management layer (DAML), wherein the DAML is configured to:
receive a first plurality of disk access requests from the plurality of modules;
generate a second plurality of disk access requests based on the first plurality of disk access requests, wherein at least one disk access request of the second plurality of disk access requests references one of the first plurality of data items stored;
obtain, for each of at least two disk access requests in the second plurality of disk access requests, data storage location information associated with a corresponding data item stored on the disk;
determine an execution sequence for the second plurality of disk access requests based on the data storage location information; and
issue the second plurality of disk access requests in the execution sequence.

16. The computer system of claim 15,
wherein the first plurality of disk access requests are received in a receive sequence; and
wherein the receive sequence order of the first plurality of disk access requests does not match the execution sequence order of corresponding requests in the second plurality of disk access requests.

17. The computer system of claim 15, wherein issuing the second plurality of disk access requests in the execution sequence is performed in response to determining that the number of disk access requests in the second plurality of disk access requests satisfies a first threshold.

18. The computer system of claim 15, wherein, to receive the first plurality of disk access requests, the DAML is further configured to receive one or more disk access requests through an application programming interface (API).

19. The computer system of claim 15, wherein, to determine the execution sequence for the second plurality of disk access requests, the DAML is further configured to determine the execution sequence such that a value indicative of a seek time associated with the second plurality of disk access requests is reduced.

20. The computer system of claim 15, wherein the plurality of modules comprises one of:
an indexing unit; and
a restoration management unit.
